(19) United States
(12) Patent Application Publication
(10) Pub. No.: US 2025/0392549 A1
(43) Pub. Date: Dec. 25, 2025

(54) Make-Before-Break Roaming

(71) Applicant: Cisco Technology, Inc., San Jose, CA (US)

(72) Inventors: Malcolm M. Smith, Richardson, TX (US); Brian D. Hart, Sunnyvale, CA (US); Maik Guenter Seewald, Nürnberg (DE)

(73) Assignee: Cisco Technology, Inc., San Jose, CA (US)

(21) Appl. No.: 18/642,483

(22) Filed: Apr. 22, 2024

Related U.S. Application Data
(60) Provisional application No. 63/497,452, filed on Apr. 21, 2023.
(60) Provisional application No. 63/502,090, filed on May 13, 2023.

(51) Int. Cl. H04L 47/34; H04L 47/32

(52) U.S. Cl. CPC H04L 47/34; H04L 47/32

(57) ABSTRACT

Make-before-break roaming may be provided. A first packet and a second packet may be created. The first packet and the second packet may comprise replicants of one another. The first packet and the second packet may comprise a sequence number. The first packet may be received by a first link and the second packet may be received by a second link. The first packet may be forwarded from the first link and the second packet may be forwarded from the second link.

### RELATED APPLICATION TECHNICAL FIELD

Under provisions of 35 U.S.C. § 119(e), Applicant claims the benefit of U.S. Provisional Application No. 63/497,452 filed Apr. 21, 2023, which is incorporated herein by reference. Under provisions of 35 U.S.C. § 119(e), Applicant claims the benefit of U.S. Provisional Application No. 63/502,090 filed May 13, 2023, which is incorporated herein by reference.

### TECHNICAL FIELD

The present disclosure relates generally to make-before-break roaming.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing make-before-break roaming;

FIG. 2 is a flow chart of a method for providing make-before-break roaming; and

FIG. 3 is a block diagram of a computing device.

### DETAILED DESCRIPTION

### Overview

Make-before-break roaming may be provided. A first packet and a second packet may be created. The first packet and the second packet may comprise replicants of one another. The first packet and the second packet may comprise a sequence number. The first packet may be received by a first link and the second packet may be received by a second link. The first packet may be forwarded from the first link and the second packet may be forwarded from the second link.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Time Sensitive Networking (TSN) is a set of Institute of Electrical and Electronic Engineers (IEEE) 802.1 Ethernet sub-standards that are defined by the IEEE TSN task group. These standards enable deterministic real-time communication over Ethernet. TSN achieves determinism over Ethernet by using time synchronization and a schedule which is shared between network components. By defining queues based on time, Time-Sensitive Networking ensures a bounded maximum latency for scheduled traffic through switched networks. This means that in a TSN network, latency of critical scheduled communication may be guaranteed.

In control applications with strict deterministic requirements, such as those found in automotive and industrial domains, TSN may offer a way to send time-critical traffic over a standard Ethernet infrastructure. This may enable the convergence of all traffic classes and multiple applications in one network. In practice this may mean that the functionality of standard Ethernet may be extended so that message latency may be guaranteed through switched networks, critical and non-critical traffic may be converged in one network, and higher layer protocols can share the network infrastructure.

IEEE 802.1 TSN networks may enable enhanced reliability via 802.1CB Frame Replication and Elimination (FRER) which duplicates Ethernet frames across multiple disjoint Layer 2 (L2) paths and eliminates duplicates (within a time-window) optionally preserving order using 802.1CB specific headers or Redundance tags (R-tags) that have stream Identifier (ID) and sequence numbers. However, this was developed assuming: i) each path is discovered and disjoint; and ii) the underlying link (e.g., Ethernet) provided in-sequence delivery of each frame.

In many instances in an enterprise network, wireless (e.g., Wi-Fi) may be the only L2 path to the end-point and thus 802.1CB may be unusable. Even though in Wi-Fi 7 with Multi-Link-Operation (MLO) two or more physical paths (e.g., one per radio) may be available (e.g., for retries but potentially including replication too) the multiple paths may not be exposed to the Logical Link Control (LLC) sublayer and above because the AP device may expose a single Media Access Control (MAC) Service Access Point (SAP) for the end-point. This design choice may make sense because all radios may be co-located on the same AP device. However, with Wi-Fi 8 Ultra High Reliability (UHR), the discussion around Make-before-break-roaming (MBBR) and/or Distributed MLO may lead to a system with multiple simultaneous 802.11 links between the end-point and different AP devices (thus distinct paths). MBBR/Distributed MLO may be architected so those multiple paths may be hidden within the MAC sublayer and terminate at a single MAC-SAP (e.g., at a single AP device) or are exposed by the MAC sublayers as multiple MAC-SAPs at the different AP devices. In the latter case, these links may involve the duplication of MAC Service Layer Units (MSDUs) (during the process of roaming for MBBR or persistently for Distributed MLO), and, in the absence of specific MAC-sublayer-countermeasures, may lead to MSDU out-of-order delivery. MSDU out-of-order delivery, however, violates a presumption of 802.1CB.

Accordingly, embodiments of the disclosure may provide a way for both protocols to act appropriately given their nature, and provide a single LLC-SAP for the end-point with in-order (if needed) and de-duplicated (if needed) Logical Link Control Sublayer Data Unit (LLCSDU) delivery. Wireless TSN (WTSN) may comprise an emerging technology for industrial and enterprise usage. IEEE 802.1CB may be the presumptive reliability booster, but was designed for Ethernet. Embodiments of the disclosure may allow this technology to be leveraged over Wi-Fi and, in doing so, may make Wi-Fi 8 more reliable especially during roaming or distributed MLO (e.g., when the end-point is persistently connected via multiple AP MLDs).

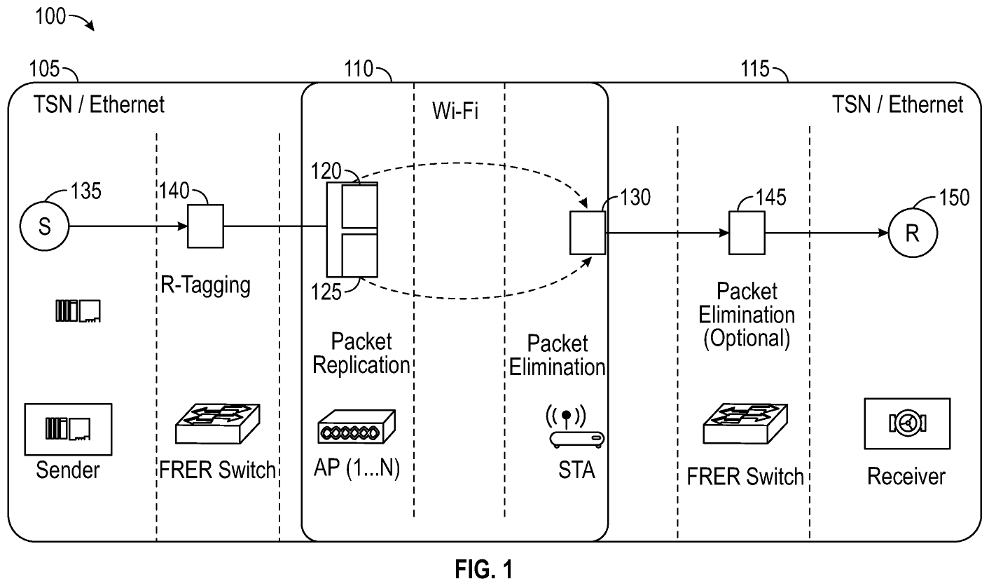

FIG. 1 shows an operating environment 100 for providing make-before-break roaming. As shown in FIG. 1, operating environment 100 may comprise a first Time Sensitive Network (TSN) 105, a wireless network 110, and a second TSN 115. Wireless network 110 may comprise, but is not limited to, a Wireless Local Area Network (WLAN) comprising a plurality of stations. The plurality of stations may comprise a plurality of Access Points (APs) and a plurality of client devices. At any given time, any one of the plurality of stations may comprise an Initiating Station (ISTA) or a Responding Station (RSTA). The plurality of APs may provide wireless network access (e.g., access to the WLAN) for the plurality of client devices. The plurality of APs may comprise a first AP 120 and a second AP 125. Each of the plurality of APs may be compatible with specification standards such as, but not limited to, the IEEE 802.11 specification standard for example. Wireless network 110 may comprise, but is not limited to, an outdoor wireless environment, such as a mesh (e.g., a Wi-Fi mesh). Embodiments of the disclosure may also apply to indoor wireless environments and non-mesh environments.

Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, an AR/VR device an Automated Transfer Vehicle (ATV), a drone, an Unmanned Aerial Vehicle (UAV), or other similar microcomputer-based device. In the example shown in FIG. 1, one of the plurality of client devices may comprise a client device 130.

A controller may comprise a Wireless Local Area Network controller (WLC) and may provision and control wireless network 110 (e.g., the WLAN). The controller may allow the plurality of client devices to join wireless network 110. In some embodiments of the disclosure, the controller may be implemented by a Digital Network Architecture Center (DNAC) controller (i.e., a Software-Defined Network (SDN) controller) that may configure information for wireless network 110 in order to provide providing make-before-break roaming consistent with embodiments of the disclosure. First TSN 105 may comprise a sender device 135 and a first Frame Replication and Elimination (FRER) switch 140. Second TSN 115 may comprise a second FRER switch 145 and a receiver device 150. First FRER switch 150 and second FRER switch 150 may comprise IEEE 802.1CB switches.

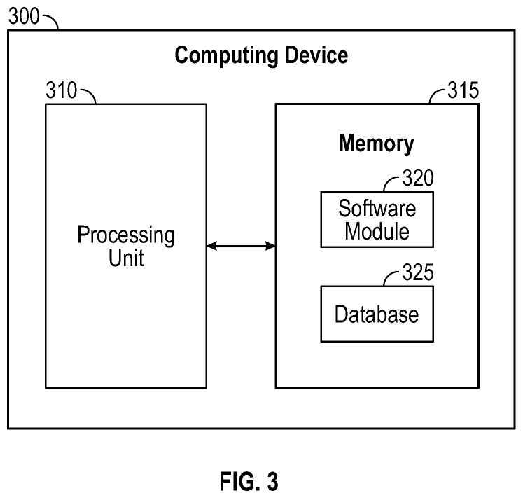

The elements described above of operating environment 100 (e.g., first AP 120, second AP 125, client device 130, sender device 135, first FRER switch 140, second FRER switch 145, and receiver device 150) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

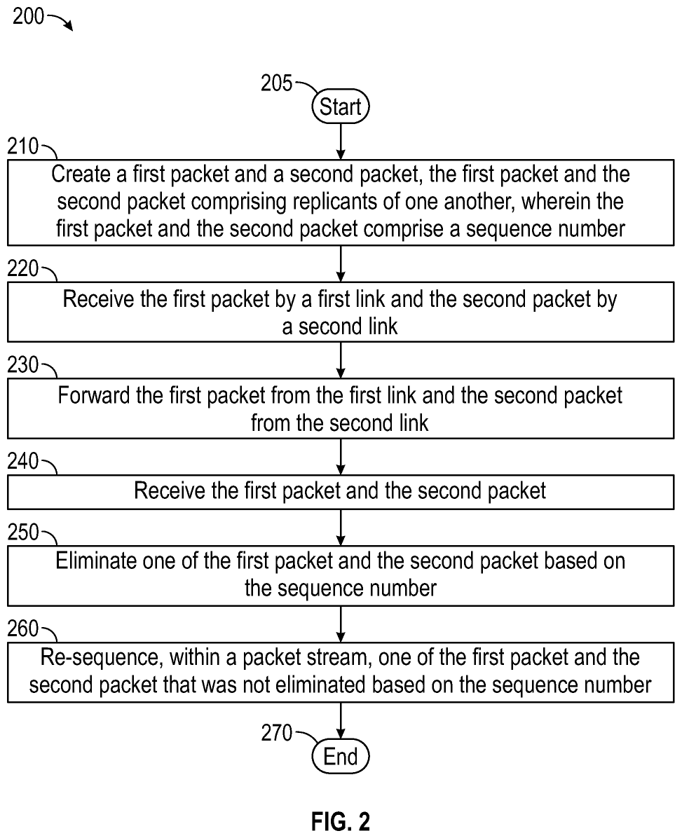

FIG. 2 is a flow chart setting forth the general stages involved in a method 200 consistent with an embodiment of the disclosure for providing make-before-break roaming. Method 200 may be implemented using devices described in more detail above with respect to FIG. 1. Ways to implement the stages of method 200 will be described in greater detail below.

As described above, because IEEE 802.1CB (FRER) is unaware of the multiplicity of 802.11 paths to a L2 end-point under Wi-Fi 8 MBBR (i.e., when there is a single MAC-SAP), IEEE 802.1CB may treat a WLAN as a single (and only path) thus not enable FRER for those streams. Similarly, Wi-Fi 8 MBBR capability may be limited in MSDU replication because there may be no MSDU sequence numbers known to the IEEE 802.11 MAC sublayer and thus no way to detect missing or duplicate MSDUs across the WLAN. Embodiments of the disclosure may provide an integration of IEEE 802.1CB (FRER) and IEEE 802.11 UHR (Wi-Fi 8).

First, with this integration, a Wi-Fi 8 UHR WLAN may determine which APs and client devices are capable of Wi-Fi 8 simultaneous-multi-AP-device-connectivity (or MBBR/Distributed MLO) and thus the possible existence of concurrent AP-device-endpoint pairs. Then it may identify whether FRER is needed on a permanent basis (e.g., distributed MLO) or temporary basis (e.g., during a roam process). Embodiments of the disclosure may then identify streams that are tolerant to frame re-ordering (e.g., Internet-of-Things) and those that are not (e.g., based on middleware tables with stream/traffic type mappings; typically provided as Electronic Digital Data Sheets). Once it identifies tolerant streams, it may identity streams that are intolerant to excess latency (e.g., based on middleware tables with stream/traffic type mappings, typically provided as Electronic Digital Data Sheets). The LLC-SAP at the (wireless) endpoint and the endpoint's peer LLC SAP (in the network) may be co-located with the entities performing the duplication and de-duplication (i.e., elimination) functions.

The Uplink (UL) FRER infrastructure de-duplication (elimination) entity may be either the: i) IEEE 802.1CB FRER switch; or the ii) WLAN. The Downlink (DL) FRER de-duplication entity may be in the end-point. The UL FRER duplication entity may be the end-point. The DL FRER duplication entity may be either the: i) IEEE 802.1CB FRER switch; or the ii) WLAN.

Method 200 may begin at starting block 205 and proceed to stage 210 where a first packet and a second packet may be created. The first packet and the second packet may replicants of one another. The first packet and the second packet may comprise a sequence number. For example, a packet stream may be transmitted from sender device 135 to receiver device 150. Before a packet in the stream is sent over the Wi-Fi network, first FRER switch 140 may replicate the packet into the first packet and the second packet, which may be replicants of one another. First FRER switch 140 may replicate MSDUs of the stream to include the R-tag and sequence numbers as it would for any other set of redundant L2 paths. In another embodiments, a controller of wireless network 110 or an AP on wireless network 110 may receive the packet from first FRER switch 140 and replicate the packet into the first packet and the second packet, which may be replicants of one another. The first packet and the second packet may include the R-tag and sequence numbers from first TSN network 105. Notwithstanding, the first packet and the second packet may be received by one or more APs in wireless network 110.

From stage 210, where the first packet and the second packet are received, method 200 may advance to stage 220 where the first packet may be received by a first link and the second packet may be received by a second link. For example, the first packet and the second packet may be received by one or more APs in wireless network 110. First link and second link may be provided by different APs or may be provided by one AP capable of MLO.

Once the first packet is received by the first link and the second packet is received by the second link in stage 220, method 200 may continue to stage 230 where the first packet may be forwarded from the first link and the second packet may be forwarded from the second link. For example, first AP 120 may transmit the first packet and second AP may transmit the second packet. In another embodiment, the first packet and the second packet may be transmitted on different radios of the same AP capable of MLO.

After the first packet is forwarded from the first link and the second packet is forwarded from the second link in stage 230, method 200 may proceed to stage 240 where the first packet and the second packet may be received. For example, the first packet and the second packet may be received by client device 130.

Once the first packet and the second packet are received in stage 240, method 200 may continue to stage 250 where one of the first packet and the second packet may be eliminated based on the sequence number. For example, client device 130 may inspect the sequence number of the first packet and the second packet and eliminate one of the two packets if they have the same sequence number. In another embodiment, second FRER switch my perform this packet elimination instead of client device 130.

After one of the first packet and the second packet is eliminated based on the sequence number in stage 250, method 200 may proceed to stage 260 where, within a packet stream, one of the first packet and the second packet that was not eliminated may be re-sequenced based on the sequence number. For example, as stated above, the packet stream may be transmitted from sender device 135 to receiver device 150. Some of these packets may be received over wireless network 110 out of sequence. In this case, using the sequence number, client device 130 or second FRER switch 145 may re-sequence the packet to its proper place within the packet stream. In this way for both protocols (IEEE 802.1CB and IEEE 802.11 MLO) may act appropriately given their nature, and provide a single LLC-SAP for the end-point with in-order (i.e., re-sequence if needed) and de-duplicated (if needed) LLCSDU delivery. In other words, embodiments of the disclosure may provide an integration of IEEE 802.1CB (FRER) and IEEE 802.11 UHR (Wi-Fi 8). Once one of the first packet and the second packet that was not eliminated is re-sequenced based on the sequence number in stage 260, method 200 may then end at stage 270.

In the Uplink (UL) direction, a packet may be provided a sequence number by client device 130 or second FRER switch 145 and sent over one of the first link or the second link on wireless network 110. If reception of the packet is not acknowledged within a predetermined period of time, the packet may be resent over another of the first link or the second link. Re-sequencing may be performed on wireless network 110 or by first FRER switch 140 for the UL.

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for providing make-before-break roaming as described above with respect to FIG. 2. Computing device 300, for example, may provide an operating environment for first AP 120, second AP 125, client device 130, sender device 135, first FRER switch 140, second FRER switch 145, and receiver device 150. First AP 120, second AP 125, client device 130, sender device 135, first FRER switch 140, second FRER switch 145, and receiver device 150 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure

1. A method comprising:
creating a first packet and a second packet, the first packet and the second packet comprising replicants of one another, wherein the first packet and the second packet comprise a sequence number;
receiving the first packet by a first link and the second packet by a second link; and
forwarding the first packet from the first link and the second packet from the second link.

2. The method of claim 1, wherein creating the first packet and the second packet is performed on an Ethernet network.

3. The method of claim 1, wherein creating the first packet and the second packet is performed on a wireless network.

4. The method of claim 1, further comprising receiving, by a computing device, the first packet and the second packet.

5. The method of claim 4, wherein the computing device comprises a client device.

6. The method of claim 4, further comprising eliminating one of the first packet and the second packet based on the sequence number.

7. The method of claim 6, further comprising resequencing, within a packet stream, one of the first packet and the second packet that was not eliminated based on the sequence number.

8. A non-transitory computer-readable medium that stores a set of instructions which when executed perform a method executed by the set of instructions comprising:
creating a first packet and a second packet, the first packet and the second packet comprising replicants of one another, wherein the first packet and the second packet comprise a sequence number;
receiving the first packet by a first link and the second packet by a second link; and
forwarding the first packet from the first link and the second packet from the second link.

9. The non-transitory computer-readable medium of claim 8, wherein creating the first packet and the second packet is performed on an Ethernet network.

10. The non-transitory computer-readable medium of claim 8, wherein creating the first packet and the second packet is performed on a wireless network.

11. The non-transitory computer-readable medium of claim 8, further comprising receiving, by a computing device, the first packet and the second packet.

12. The non-transitory computer-readable medium of claim 11, wherein the computing device comprises a client device.

13. The non-transitory computer-readable medium of claim 11, further comprising eliminating one of the first packet and the second packet based on the sequence number.

14. The non-transitory computer-readable medium of claim 13, further comprising resequencing, within a packet stream, one of the first packet and the second packet that was not eliminated based on the sequence number.

15. A system comprising:
a first memory storage; and
a first processing unit coupled to the first memory storage, wherein the first processing unit is operative to:
create a first packet and a second packet, the first packet and the second packet comprising replicants of one another, wherein the first packet and the second packet comprise a sequence number;
receive the first packet by a first link and the second packet by a second link; and
forward the first packet from the first link and the second packet from the second link.

16. The system of claim 15, wherein the first processing unit being operative to create the first packet and the second packet is performed on an Ethernet network.

17. The system of claim 15, wherein the first processing unit being operative to create the first packet and the second packet is performed on a wireless network.

18. The system of claim 15, further comprising:
a second memory storage; and
a second processing unit coupled to the second memory storage, wherein the second processing unit is operative to receive the first packet and the second packet.

19. The system of claim 18, wherein the second processing unit is disposed in a client device.

20. The system of claim 18, wherein the second processing unit is further operative to eliminate one of the first packet and the second packet based on the sequence number.
